(19) United States
(12) Patent Application Publication
(10) Pub. No.: US 2026/0188260 A1
(43) Pub. Date: Jul. 2, 2026

(54) BUFFER CIRCUIT, SOURCE DRIVER, AND DISPLAY DEVICE INCLUDING THE SAME

(71) Applicant: Samsung Electronics Co., Ltd., Suwon-si (KR)

(72) Inventors: SeungUk Baek, Suwon-si (KR); JIHOON KIM, Suwon-si (KR); YOUNG-BAE MOON, Suwon-si (KR); KEUNHWA PARK, Suwon-si (KR); SUNG-JIN PARK, Suwon-si (KR); Seungmin Yoon, Suwon-si (KR); YUNSEOK JANG, Suwon-si (KR)

(21) Appl. No.: 19/300,342

(22) Filed: Aug. 14, 2025

(30) Foreign Application Priority Data
Dec. 31, 2024 (KR) 10-2024-0202591

(51) Int. Cl. G09G 3/3275; G09G 3/36

(52) U.S. Cl. CPC G09G 3/3275; G09G 3/3688; G09G 2310/027; G09G 2310/0286; G09G 2310/0289; G09G 2310/0291; G09G 2310/08

(57) ABSTRACT

According to an embodiment, a buffer circuit comprises an operational amplifier configured to output an output voltage based on a voltage of a first output node and a second output node which vary in response to an input voltage of the operational amplifier; and a slew rate compensating circuit configured to receive the input voltage and the output voltage, generate a compensation voltage based on the input voltage, generate a compensation current based on the compensation voltage, and supply the compensation current to the first output node or the second output node.

### CROSS-REFERENCE TO RELATED APPLICATION

This application claims priority under 35 U.S.C. § 119 to and the benefit thereof of Korean Patent Application No. 10-2024-0202591, filed with the Korean Intellectual Property Office on Dec. 31, 2024, the entire contents of which are incorporated herein by reference.

### BACKGROUND

### 1. Field

The present disclosure relates to a buffer circuit, a source driver, and a display device including the same.

### 2. Description of the Related Art

Generally, a display device displays images to provide various visual information to a user. A display panel of the display device may include a plurality of pixels, and each of the plurality of pixels emits light with a predetermined luminance to display images. A display driver integrated circuit (DDI) may be used to drive these pixels.

In recent years, there has been a focus on reducing the power consumption of display devices. One method involves driving the DDI at a lower driving voltage. However, this may lead to a slower slew rate in a buffer circuit of the DDI. On the other hand, a higher display frame rate may be required improve the user experience. Therefore, studies have been conducted to find ways to increase a slew rate of the buffer circuit while maintaining low power consumption.

### SUMMARY

One or more embodiments of the present disclosure provide a buffer circuit having a high slew rate, a source driver, and a display device including the same.

The present disclosure provides a buffer circuit, a source driver, and a display device including the same, which may operate through a small voltage difference between the input voltage and the output voltage.

According to an embodiment, a buffer circuit comprises an operational amplifier configured to output an output voltage based on a voltage of a first output node and a second output node which vary in response to an input voltage of the operational amplifier; and a slew rate compensating circuit configured to receive the input voltage and the output voltage, generate a compensation voltage based on the input voltage, generate a compensation current based on the compensation voltage, and supply the compensation current to the first output node or the second output node.

According to an embodiment, a source driver comprises a shift register configured to sample data in response to a horizontal synchronization signal and output sampled image data; a level shifter configured to shift a voltage level of the image data; a digital-analog converter (DAC) configured to generate an analog signal corresponding to the image data having the shifted voltage level; and an output buffer circuit configured to buffer the analog signal and output the buffered analog signal as a data signal to source lines, generate a compensation voltage based on the buffered analog signal, and generate a compensation current based on the compensation voltage to cause the data signal to rise or fall.

According to an embodiment, a display device comprises a pixel array comprising a plurality of pixels; a timing controller configured to receive an image signal from an outside and generate image data by separating the image signal; and a source driver configured to convert the image data into a data signal, generate a compensation voltage based on an analog signal corresponding to the image data, and generate a compensation current based on the compensation voltage to cause the data signal to rise or fall.

### BRIEF DESCRIPTION OF THE DRAWINGS

FIG. 1 is a circuit diagram of a buffer circuit according to an example embodiment.

FIG. 2 is a block diagram of a buffer circuit according to an example embodiment.

FIG. 3 is a circuit diagram illustrating the input stage and bias circuits included in the buffer circuit according to an example embodiment.

FIG. 4 is a circuit diagram illustrating a load stage and an output stage included in the buffer circuit according to an example embodiment.

FIG. 5 is a block diagram illustrating a slew rate compensating circuit of a buffer circuit according to an example embodiment.

FIG. 6 is a circuit diagram of a slew rate compensating circuit of a buffer circuit according to an example embodiment.

FIG. 7 is a diagram for explaining the operation of the slew rate compensating circuit according to an example embodiment.

FIG. 8 is a graph for explaining the operation of a buffer circuit according to an example embodiment.

FIG. 9 is a diagram for explaining the operation of a slew rate compensating circuit according to an example embodiment.

FIG. 10 is a graph for explaining the operation of the buffer circuit according to an example embodiment.

FIG. 11 is a circuit diagram of a slew rate compensating circuit of a buffer circuit according to an example embodiment.

FIG. 12 is a timing diagram illustrating the input voltage of a buffer circuit according to an example embodiment.

FIG. 13 is a timing diagram illustrating the output voltage when an input voltage according to FIG. 12 is applied to a buffer circuit according to an example embodiment.

FIG. 14 is a block diagram illustrating a source driver including a buffer circuit according to an example embodiment.

FIG. 15 is a block diagram illustrating a display device including a source driver according to an example embodiment.

FIG. 16 is a diagram for explaining a display system according to an example embodiment.

### DETAILED DESCRIPTION OF THE EMBODIMENTS

In the following detailed description, only certain exemplary embodiments have been shown and described, simply by way of illustration. As those skilled in the art would realize, the described embodiments may be modified in various different ways, all without departing from the spirit or scope of the present inventive concepts.

Accordingly, the drawings and description are to be regarded as illustrative in nature and not restrictive. Like reference numerals designate like elements throughout the specification. In the description, an operation order may be changed, several operations may be merged or some operation may be divided or a specific operation may not be performed.

Further, elements described as a singular form may be interpreted as singular or plural unless explicit expression such as “one” or “single” is used. Terms including an ordinal number, such as first and second, are used for describing various constituent elements, but the constituent elements are not limited by the terms. The terms are used only to discriminate one constituent element from another constituent element.

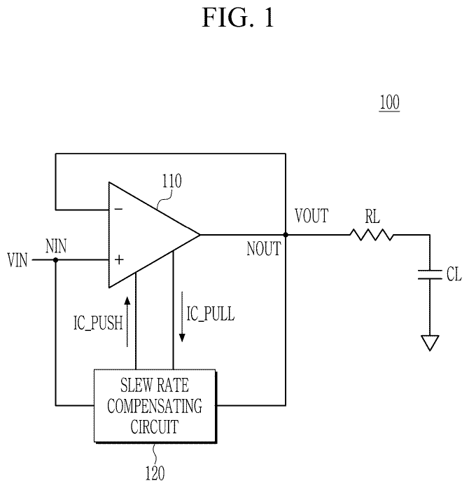

FIG. 1 is a circuit diagram of a buffer circuit according to an example embodiment.

Referring to FIG. 1, a buffer circuit 100 may include an operational amplifier 110 and a slew rate compensating circuit 120.

The buffer circuit 100 may receive an input voltage VIN through the input node NIN. The buffer circuit 100 may buffer an input voltage VIN and output an output voltage VOUT. The buffer circuit 100 may be connected to an output node NOUT and the output node NOUT may be connected to a load resistor RL and a load capacitor CL. As the distance increases from the output node NOUT, transmission of the output voltage VOUT may be delayed by the load resistor RL and the load capacitor CL.

The operational amplifier 110 may amplify the input voltage VIN and output the output voltage VOUT at the output stage. The first input stage (e.g., the non-inverting input stage) (+) of the operational amplifier 110 may be connected to the input node NIN. The operational amplifier 110 may receive the input voltage VIN. The second input stage (e.g., the inverting input stage) (−) of the operational amplifier 110 may be connected to the output node NOUT. The output stage of the operational amplifier 110 is connected to the output node NOUT and may output the output voltage VOUT.

The slew rate compensating circuit 120 may generate compensation currents IC_PUSH, IC_PULL based on the voltage difference between the input voltage VIN and the output voltage VOUT. The slew rate compensating circuit 120 may receive the input voltage VIN and the output voltage VOUT. The slew rate compensating circuit 120 may output the compensation currents IC_PUSH, IC_PULL to the operational amplifier 110. The slew rate compensating circuit 120 may be connected to the first input stage (+) and the output stage of the operational amplifier 110. The slew rate compensating circuit 120 may reduce the transition time when the output voltage VOUT of the operational amplifier 110 decreases by the second compensation current IC_PUSH, and reduce the transition time when the output voltage VOUT of the operational amplifier 110 rises by the first compensation current IC_PULL.

According to one embodiment, the slew rate compensating circuit 120 may generate compensation currents IC_PUSH, IC_PULL even with a small voltage difference between the input voltage VIN and the output voltage VOUT. For example, the slew rate compensating circuit 120 may generate compensation currents IC_PUSH, IC_PULL even if the voltage difference between the input voltage VIN and the output voltage VOUT is smaller than a reference voltage level. For instance, the reference voltage level may include the voltage level of the threshold voltage of an NFET (N-channel Field Effect Transistor) or the voltage level of the threshold voltage of a PFET (P-channel Field Effect Transistor) constituting the slew rate compensating circuit 120. In other words, the slew rate compensating circuit 120 may generate compensation currents IC_PUSH, IC_PULL in the dead zone where the input voltage VIN rises above the reference voltage level and where the input voltage VIN falls below the reference voltage level. Accordingly, the slew rate compensating circuit 120 may improve the slew rate of a buffer circuit 100 that operates at a low drive voltage.

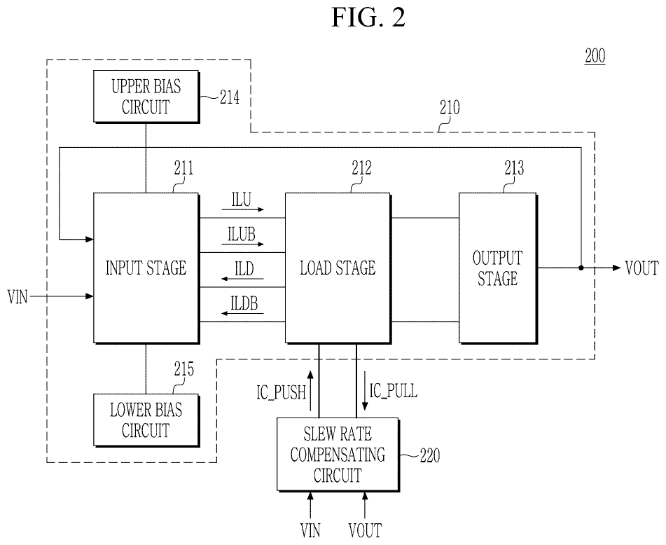

FIG. 2 is a block diagram of a buffer circuit according to an embodiment.

Referring to FIG. 2, the buffer circuit 200 may include an operational amplifier 210 and a slew rate compensating circuit 220. The operational amplifier 210 may have a rail-to-rail structure having a dual input stage structure. Meanwhile, the embodiments are not limited to this, and the input stage of the operational amplifier 210 may have a single structure.

The operational amplifier 210 may amplify an input voltage VIN to generate an output voltage VOUT. The operational amplifier 210 may include an input stage 211, a load stage 212, an output stage 213, an upper bias circuit 214, and a lower bias circuit 215.

The input stage 211 may receive the input voltage VIN and may also receive the output voltage VOUT as feedback, and may determine a magnitude difference of the input voltage VIN and the output voltage VOUT.

The load stage 212 may receive the first compensation current IC_PULL and the second compensation current IC_PUSH from the slew rate compensating circuit 220. The load stage 212 may perform slew rate compensation operation using the first compensation current IC_PULL and the second compensation current IC_PUSH. The load stage 212 may generate load currents ILU, ILUB, ILD, and ILDB corresponding to a voltage difference of the input voltage VIN and the output voltage VOUT and may supply the load currents ILU, ILUB, ILD, and ILDB to the input stage 211.

The upper bias circuit 214 and the lower bias circuit 215 may supply bias currents to the input stage 211.

The output stage 213 may be connected to the load stage 212. The output stage 213 may be connected to the load stage 212 through at least one of a push connection node and a pull connection node. The output stage 213 may generate an output voltage VOUT by buffering the output signal of the load stage 212. The output stage 213 may output the output voltage VOUT to the outside of the buffer circuit 200.

The slew rate compensating circuit 220 may generate compensation currents IC_PUSH, IC_PULL based on the difference between the input voltage VIN and the output voltage VOUT. The slew rate compensating circuit 220 may provide the compensation currents IC_PUSH, IC_PULL to the load stage 212. The slew rate compensating circuit 220 may reduce the transition time of the output voltage VOUT.

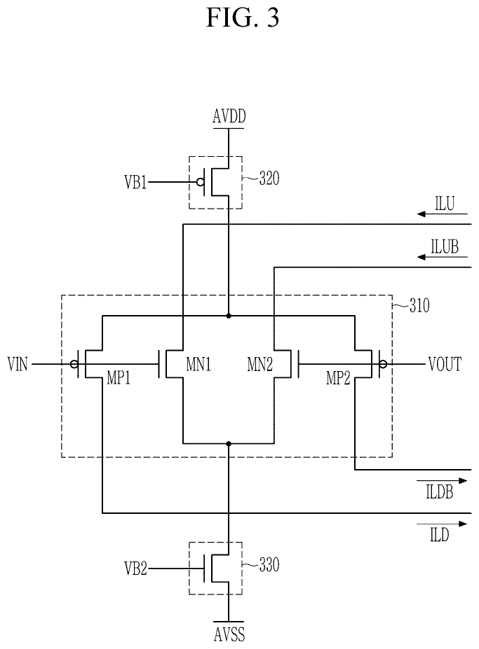

FIG. 3 is a circuit diagram illustrating the input stage and bias circuits included in a buffer circuit according to an example embodiment. The input stage 310, upper bias circuit 320, and lower bias circuit 330 of FIG. 3 respectively correspond to the input stage 211, upper bias circuit 214, and lower bias circuit 215 of FIG. 2.

Referring to FIGS. 2 and 3, the input stage 310 may have a rail-to-rail structure with a dual configuration. The input stage 310 may include a first input stage that receives pulling load current ILD, ILDB from the load stage 212, and a second input stage that receives pushing load current ILU, ILUB from the load stage 212. The first input stage may include PMOS transistors MP1, MP2, and the second input stage may include NMOS transistors MN1, MN2.

The upper bias circuit 320 may provide a first bias current to the first input stage based on the bias voltage VB1. The upper bias circuit 320 may be gated to the first bias voltage VB1. The upper bias circuit 320 may include a transistor that provides the power supply power voltage AVDD to the input stage 310.

The lower bias circuit 330 may provide a second bias current to the second input stage based on the bias voltage VB2. The lower bias circuit 330 may be gated by the second bias voltage VB2. The lower bias circuit 330 may include a transistor that provides the ground power voltage AVSS to the input stage 310.

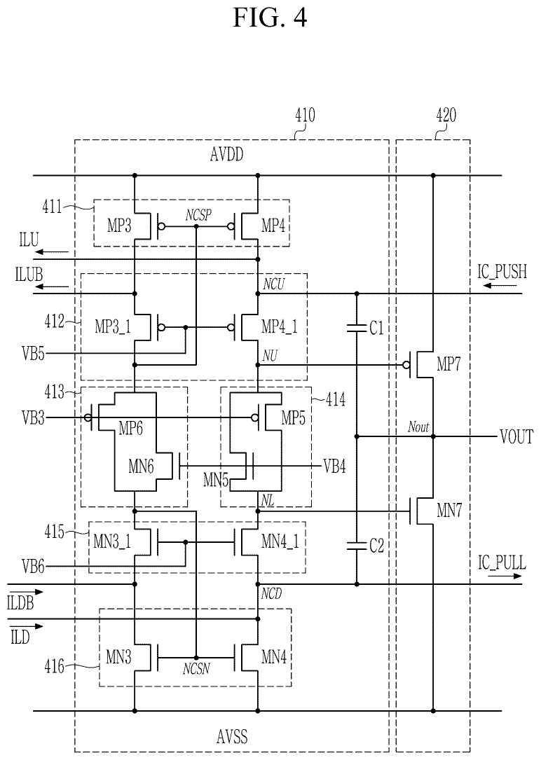

FIG. 4 is a circuit diagram illustrating the load stage and output stage included in a buffer circuit according to an example embodiment. The load stage 410 and output stage 420 of FIG. 4 respectively correspond to the load stage 212 and output stage 213 of FIG. 2.

Referring to FIG. 2 and FIG. 4, the load stage 410 may include an upper current mirror circuit 411, a lower current mirror circuit 416, an upper cascode circuit 412, a lower cascode circuit 415, a first connection circuit 413, a second connection circuit 414, a first capacitor C1, and a second capacitor C2.

The upper current mirror circuit 411 may include PMOS transistors MP3, MP4 connected in the form of a current mirror. The upper current mirror circuit 411 is electrically connected to the second input stage of the input stage 211 and may supply a pushing load current ILU, ILUB to the load stage 410.

The lower current mirror circuit 416 may include NMOS transistors MN3, MN4 connected in the form of a current mirror. The lower current mirror circuit 416 is electrically connected to the first input stage of the input stage 211 and may supply pulling load current ILD, ILDB to the load stage 410.

The first connection circuit 413 may include a PMOS transistor MP6 which operates in response to a third bias voltage VB3 and an NMOS transistor MN6 which operates in response to a fourth bias voltage VB4. The first connection circuit 413 may electrically connect the first output node NCSP and the first output node NCSN.

The second connection circuit 414 may include a PMOS transistor MP5 operating in response to a third bias voltage VB3 and an NMOS transistor MN5 operating in response to a fourth bias voltage VB4. The second connection circuit 414 may electrically connect the second output node NU and the second output node NL.

The upper cascode circuit 412 may be connected between the upper current mirror circuit 411 and the connection circuits 413, 414. The upper cascode circuit 412 may include PMOS transistors MP3_1, MP4_1 that operate in response to the bias voltage VB5.

The lower cascode circuit 415 may be connected between the lower current mirror circuit 416 and the connection circuits 413, 414. The lower cascode circuit 415 may include NMOS transistors MN3_1, MN4_1 that operate in response to the bias voltage VB6.

The first capacitor C1 may be connected between the third output node NCU and the output node NOUT of the output stage 150.

The second capacitor C2 may be connected between the third output node NCD and the output node NOUT of the output stage 150.

The output stage 420 may include a PMOS transistor MP7 and an NMOS transistor MN7. The PMOS transistor MP7 may have a gate connected to the second output node NU and be connected between the third output node NCU and the output node NOUT. The NMOS transistor MN7 may have a gate connected to the second output node NL and be connected between the third output node NCD and the output node NOUT.

The second compensation current IC_PUSH may be provided to the third output node NCU, and the first compensation current IC_PULL may be provided to the third output node NCD. The pushing load current ILU flows from the third output node NCU to the second input stage, which is composed of NMOS transistors (MN1, MN2 in FIG. 3) included in the input stage 310. The pushing load current ILUB may flow from the load stage 410 to the first input stage included in the input stage 310.

The pulling load current ILD flows from the first input stage, which is composed of PMOS transistors (MP1, MP2 in FIG. 3) included in the input stage 310, to the third output node NCD, and the pulling load current ILDB may flow from the first input stage to the load stage 410.

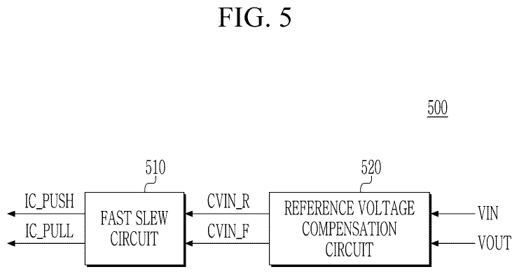

FIG. 5 is a block diagram illustrating the slew rate compensating circuit of a buffer circuit according to an example embodiment. The slew rate compensating circuit 500 of FIG. 5 corresponds to the slew rate compensating circuit 220 of FIG. 2.

Referring to FIG. 5, the slew rate compensating circuit 500 may include a fast slew circuit 510 and a reference voltage compensation circuit 520.

The reference voltage compensation circuit 520 may receive the input voltage VIN and the output voltage VOUT, and generate a compensation voltage CVIN_R, CVIN_F based on the input voltage VIN. In one embodiment, when a sudden voltage difference occurs between the input voltage VIN and the output voltage VOUT, the reference voltage compensation circuit 520 may generate a compensation voltage CVIN_R, CVIN_F.

The reference voltage compensation circuit 520 may generate a compensation voltage CVIN_R by adding a reference voltage to the input voltage VIN when the input voltage VIN is greater than the output voltage VOUT. The reference voltage compensation circuit 520 may generate a compensation voltage CVIN_F by subtracting the reference voltage from the input voltage VIN when the output voltage VOUT is greater than the input voltage VIN. For example, the reference voltage may be the threshold voltage of the input transistor of the fast slew circuit 510. The reference voltage compensation circuit 520 may also generate compensation voltages CVIN_R, CVIN_F within a plurality of regions where the input voltage VIN and output voltage VOUT have a voltage difference smaller than the threshold voltage.

The fast slew circuit 510 may receive compensation voltages CVIN_R, CVIN_F and generate compensation currents IC_PULL/IC_PUSH corresponding to the compensation voltages CVIN_R, CVIN_F. The fast slew circuit 510 may perform a current mirror operation for the current flowing according to the application of the compensation voltage CVIN_R and generate the first compensation current IC_PULL. The fast slew circuit 510 may perform a current mirror operation for the current flowing according to the application of the compensation voltage CVIN_F and generate the second compensation current IC_PUSH.

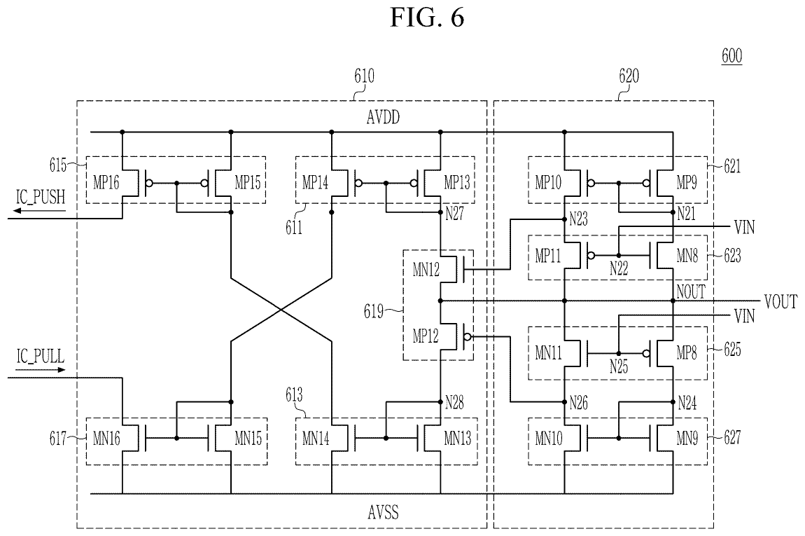

FIG. 6 is a circuit diagram of a slew rate compensating circuit of a buffer circuit according to an example embodiment. The slew rate compensating circuit 600 of FIG. 6 corresponds to the slew rate compensating circuit 220 of FIG. 2.

Referring to FIG. 6, the slew rate compensating circuit 600 may include a fast slew circuit 610 and a reference voltage compensation circuit 620. The slew rate compensating circuit 600 may generate a first compensation current IC_PULL or a second compensation current IC_PUSH based on the difference between the input voltage VIN and the output voltage VOUT.

The reference voltage compensation circuit 620 may include an output node NOUT to which the output voltage VOUT is applied, an upper current mirror circuit 621, a first connection circuit 623, a lower current mirror circuit 627, and a second connection circuit 625.

The upper current mirror circuit 621 may include PMOS transistors MP9, MP10 connected in the form of a current mirror. The upper current mirror circuit 621 may be connected between the first node N21, the third node N23, and the supply power voltage AVDD. In one embodiment, the current ratio of the upper current mirror circuit 621 may be 1:1, but it is not limited thereto.

The first connection circuit 623 may provide a bias voltage for the upper current mirror circuit 621 to perform the current mirroring operation. The first connection circuit 623 may include an NMOS transistor MN8 and a PMOS transistor MP11. The gates of the NMOS transistor MN8 and the PMOS transistor MP11 may be connected to second node N22. Second node N22 may be the input node NIN. An input voltage VIN may be commonly applied to the gates of the NMOS transistor MN8 and the PMOS transistor MP11.

The lower current mirror circuit 627 may include NMOS transistors MN9, MN10 connected in the form of a current mirror. The lower current mirror circuit 627 may be connected between the fourth node N24, the sixth node N26, and the ground power voltage AVSS. In one embodiment, the current ratio of the lower current mirror circuit 627 may be 1:1, but it is not limited thereto.

The second connection circuit 625 may provide a bias voltage for the lower current mirror circuit 627 to perform the current mirroring operation. The second connection circuit 625 may include a PMOS transistor MP8 and an NMOS transistor MN11. The gates of the PMOS transistor MP8 and the NMOS transistor MN11 may be connected to fifth node N25. Fifth node N25 may be an input node NIN. An input voltage VIN may be commonly applied to the gates of the PMOS transistor MP8 and the NMOS transistor MN11. An input voltage VIN may be commonly applied to the gates of the PMOS transistor MP8 and the NMOS transistor MN11.

The compensation voltage CVIN_R may be generated based on the voltage of third node N23, which is the source of the PMOS transistor MP11. The compensation voltage CVIN_F may be generated based on the voltage of sixth node N26, which is the source of the NMOS transistor MN11.

The fast slew circuit 610 may include a first upper current mirror circuit 611, a first lower current mirror circuit 613, a second upper current mirror circuit 615, a second lower current mirror circuit 617, and a compensation circuit 619.

The compensation circuit 619 may include an NMOS transistor MN12 and a PMOS transistor MP12 connected in series. The gate of the NMOS transistor MN12 is connected to the third node N23, the source is connected to the output node NOUT, and the drain may be connected to the seventh node N27. For example, the NMOS transistor MN12 may receive a compensation voltage CVIN_R from the reference voltage compensation circuit 620 through the gate. The gate of the PMOS transistor MP12 is connected to the sixth node N26, the source is connected to the output node NOUT, and the drain may be connected to the eighth node N28. For example, the PMOS transistor MP12 may receive a compensation voltage CVIN_F from the reference voltage compensation circuit 620 through the gate.

The first upper current mirror circuit 611 may include PMOS transistors MP13, MP14 connected in the form of a current mirror. The PMOS transistor MP13 may include a source connected to the supply power voltage AVDD, and a drain and gate connected to the seventh node N27. The PMOS transistor MP14 may include a source connected to the supply power voltage AVDD, a drain connected to the drain of the NMOS transistor MN15, and a gate connected to the seventh node N27.

The first lower current mirror circuit 613 may include NMOS transistors MN13, MN14 connected in the form of a current mirror. The NMOS transistor MN13 may include a source connected to the ground power voltage AVSS, and a drain and gate connected to the eighth node N28. The NMOS transistor MN14 may include a source connected to the ground power voltage AVSS, a drain connected to the drain of the PMOS transistor MP15, and a gate connected to the eighth node N28.

The second upper current mirror circuit 615 may include PMOS transistors MP15, MP16 connected in the form of a current mirror. The PMOS transistor MP15 may include a source connected to the supply power voltage AVDD, and a drain and gate connected to the drain of the NMOS transistor MN14. The PMOS transistor MP16 may include a source connected to the supply power voltage AVDD, a drain from which the second compensation current IC_PUSH is output, and a gate connected to the drain of the NMOS transistor MN14.

The second lower current mirror circuit 617 may include NMOS transistors MN15, MN16 connected in the form of a current mirror. The NMOS transistor MN15 may include a source connected to the ground power supply AVSS, and a drain and gate connected to the drain of the PMOS transistor MP14. The NMOS transistor MN16 may include a source connected to the ground power voltage AVSS, a drain from which the first compensation current IC_PULL is output, and a gate connected to the drain of the PMOS transistor MP14.

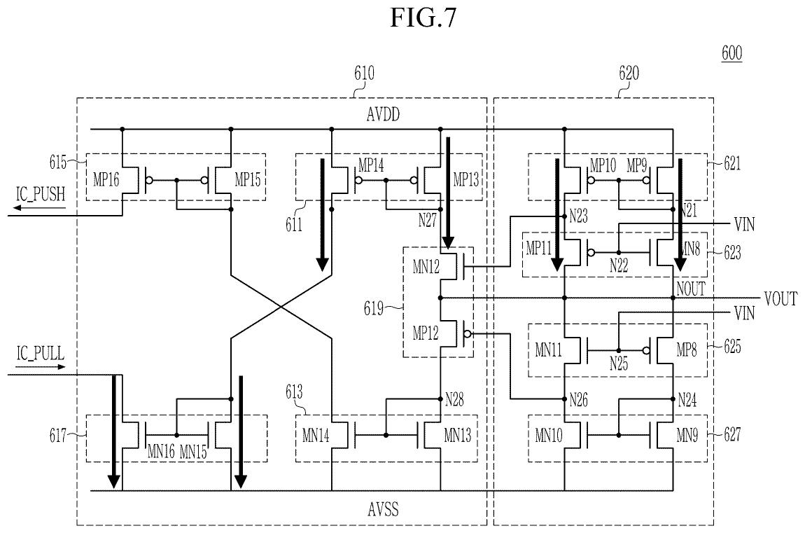

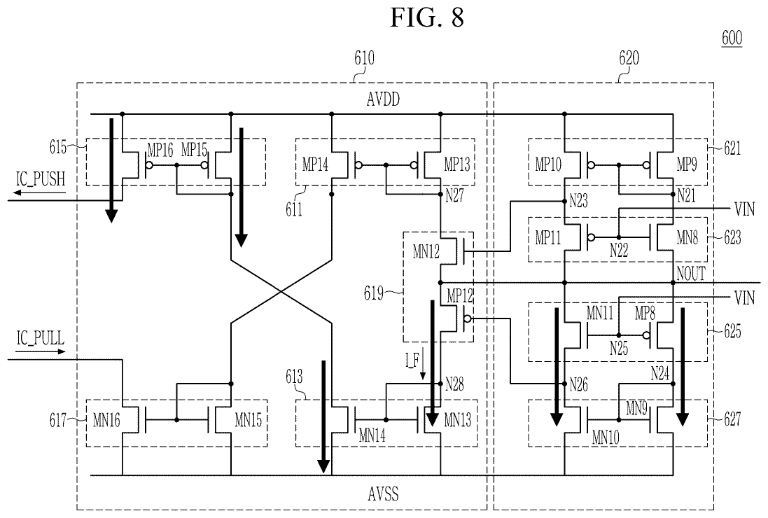

FIG. 7 is a diagram for explaining the operation of a slew rate compensating circuit according to an example embodiment. FIG. 8 is a graph for explaining the operation of a buffer circuit according to an example embodiment.

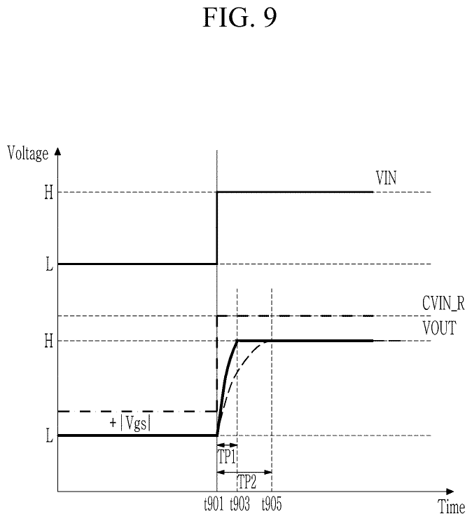

Specifically, FIG. 7 describes the flow of current within the slew rate compensating circuit and the first current IC_PUSH when the first input voltage VIN rises. FIG. 9 illustrates the waveform of the output voltage VOUT according to the input voltage VIN.

Below, with reference to FIGS. 3 to 5, 7, and 9, the operation of the buffer circuit according to one example embodiment will be described.

A buffer circuit may increase the slew rate of the output voltage VOUT of the buffer circuit using the slew rate compensating circuits 500, 600 shown in FIGS. 5 and 6.

Until t901, before the input voltage VIN rises, both the input voltage VIN and the output voltage VOUT may be maintained at a low level L.

At t901, when a magnitude of the input voltage VIN is greater than a magnitude of the output voltage VOUT, a magnitude of the pulling load current ILD of the first input stage configured by the PMOS transistors MP1 and MP2 included in the input stage 310 may be reduced and the pulling load current ILDB may be increased. Further, the magnitude of the pushing load current ILU of the second input stage configured by the NMOS transistors MN1 and MN2 included in the input stage 310 may be increased and the pushing load current ILUB may be reduced. At this time, the voltage of the first output node NCU of the upper current mirror circuit 411 of the load stage 410 may be reduced and the voltage of the second output node NCSP may be increased. Further, the voltage of the first output node NCD of the lower current mirror circuit 416 of the load stage 410 may be reduced and the voltage of the second output node NCSN may be increased. In other words, when the magnitude of the input voltage VIN is greater than the magnitude of the output voltage VOUT, the voltage of the first output node NCU of the upper current mirror circuit 411 of the load stage 410 and the voltage of the first output node NCD of the lower current mirror circuit 416 of the load stage 410 may decrease.

When the magnitude of the input voltage VIN is greater than the magnitude of the output voltage VOUT by a first voltage, and the first voltage is greater than or equal to the threshold voltage of the NMOS transistor MN8, the NMOS transistor MN8 of the reference voltage compensation circuit 620 in FIG. 7 may be turned on. Through the operation of the current mirror MP9, MP10 in the upper current mirror circuit 621, the PMOS transistor MP11 may be turned on. When the PMOS transistor MP11 is turned on, it may operate as a source follower. The input voltage VIN is applied to the gate of the PMOS transistor MP11, the output voltage VOUT is applied to the drain, and the source may have a voltage that adds the |Vgs| of the PMOS transistor MP11 to the input voltage VIN. For example, the third node N23 may have a compensation voltage CVIN_R that adds the |Vgs| value of the PMOS transistor MP11 to the input voltage VIN.

Accordingly, the sum of the input voltage VIN and |Vgs| may be applied to the gate of the NMOS transistor MN12. Subsequently, through the current mirror operation of the first upper current mirror circuit 611, current flows to the PMOS transistor MP14, and through the current mirror operation of the second lower current mirror circuit 617, the first compensation current IC_PULL may flow to the NMOS transistor MN16. The first compensation current IC_PULL may flow from the first output node NCD of the load stage 410 to the NMOS transistor MN16. In other words, the fast slew circuit 610 may pull the first compensation current IC_PULL.

At this time, the voltage of the first output node NCD of the load stage 410 may be further lowered by the first compensation current IC_PULL. The NMOS transistor MN7 of the output stage 420 is quickly turned off by the first compensation current IC_PULL, and the drop of the output voltage VOUT caused by the NMOS transistor MN7 is prevented, so the rising time of the output voltage VOUT can be shortened. Since the voltage of node N27, which is higher than the input voltage VIN by Vgs, is applied as an input to the fast slew circuit 610, the fast slew circuit 610 may operate without a dead zone for the input voltage VIN.

Meanwhile, when the magnitude of the input voltage VIN is greater than the magnitude of the output voltage VOUT, the PMOS transistor MP8 included in the reference voltage compensation circuit 620 is turned off, and since no current flows through the PMOS transistor MP8, the second compensation current IC_PUSH does not occur. In other words, the second compensation current IC_PUSH is not supplied to the load stage 410.

After the t903, the input voltage VIN and the output voltage VOUT may be maintained at a high level H.

As shown in FIG. 9, the fast slew circuit 610 may increase the slew rate by inputting the compensation voltage CVIN_R (i.e., the voltage of third node N23) to the gate of the NMOS transistor MN12 of the compensation circuit 619, even if the difference between the input voltage VIN and the output voltage VOUT is small.

When the input voltage VIN transitions from a low level L to a high level H, the transition period TP1(t901 to t903) of the output voltage VOUT when slew rate compensation is performed using the buffer circuit according to an embodiment is shorter than the transition period TP2(t901 to t905) of the output voltage VOUT when slew rate compensation is not performed.

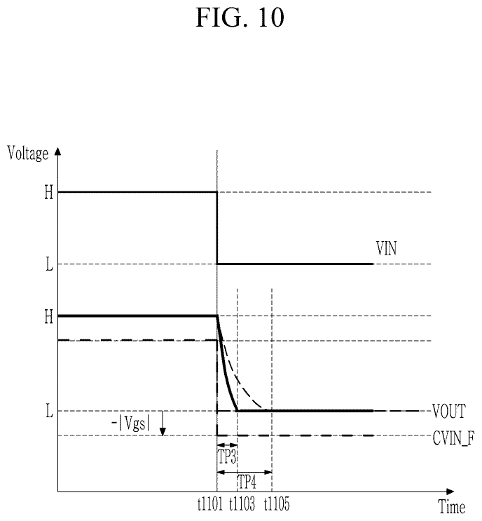

FIG. 8 is a diagram for explaining the operation of the slew rate compensating circuit according to one example embodiment. FIG. 10 is a graph for explaining the operation of the buffer circuit according to one example embodiment.

Specifically, FIG. 8 explains the flow of current within the slew rate compensating circuit and the first compensation current IC_PULL when the first input voltage VIN decreases. FIG. 10 illustrates the waveform of the output voltage VOUT according to the input voltage VIN.

Below, with reference to FIGS. 3 to 5, 8, and 10, the operation of the buffer circuit according to one embodiment will be described.

The buffer circuit may increase the slew rate of the output voltage VOUT of the buffer circuit using the slew rate compensating circuits 500, 600 of FIGS. 5 and 6.

Until t1101, before the input voltage VIN drops, both the input voltage VIN and the output voltage VOUT may be maintained at a high level H.

At t1101, when a magnitude of the input voltage VIN becomes smaller than a magnitude of the output voltage VOUT, a magnitude of the pulling load current ILD of the first input stage configured by the PMOS transistors MP1 and MP2 included in the input stage 310 may be increased and the pulling load current ILDB may be decreased. Further, the magnitude of the pushing load current ILU of the second input stage configured by the NMOS transistors MN1 and MN2 included in the input stage 310 may be decreased and the pushing load current ILUB may be increased. At this time, the voltage of the first output node NCU of the upper current mirror circuit 411 of the load stage 410 may be increased and the voltage of the second output node NCSN may be decreased. In other words, when the magnitude of the output voltage VOUT is greater than the magnitude of the input voltage VIN, the voltage at the first output node NCU of the upper current mirror circuit 411 of the load stage 410 and the voltage at the first output node NCD of the lower current mirror circuit 416 of the load stage 410 may increase.

When the magnitude of the input voltage VIN is smaller than the magnitude of the output voltage VOUT by a second voltage, and the second voltage is greater than or equal to the threshold voltage of the PMOS transistor MP8, the PMOS transistor MP8 of the reference voltage compensation circuit 620 in FIG. 8 may be turned on. Through the operation of the current mirror MN9, MN10 of the lower current mirror circuit 627, the NMOS transistor MN11 may be turned on. When the NMOS transistor MN11 is turned on, the input voltage VIN is applied to the gate of the NMOS transistor MN11, the output voltage VOUT is applied to the drain, and the source may have a voltage obtained by subtracting the Vgs of the NMOS transistor MN11 from the input voltage VIN. In other words, sixth node N26 may have a compensation voltage CVIN_F obtained by subtracting the Vgs value of the NMOS transistor MN11 from the input voltage VIN.

Accordingly, a voltage having a value obtained by subtracting Vgs from the input voltage VIN may be applied to the gate of the PMOS transistor MP12. Subsequently, through the current mirror operation of the first lower current mirror circuit 613, current flows to the NMOS transistor MN14, and through the current mirror operation of the second upper current mirror circuit 615, a second compensation current IC_PUSH may flow to the PMOS transistor MP16. The second compensation current IC_PUSH may flow from the PMOS transistor MP16 to the first output node NCU of the load stage 410. In other words, the fast slew circuit 610 may push the second compensation current IC_PUSH.

At this time, the voltage of the first output node NCU of the load stage 410 may be further increased by the second compensation current IC_PUSH. Therefore, the PMOS transistor MP7 of the output stage 420 is quickly turned off by the second compensation current IC_PUSH, and the rise of the output voltage VOUT caused by the PMOS transistor MP7 is prevented, so the falling time of the output voltage VOUT can be shortened. Since the voltage of the node N28, which is lower than the input voltage VIN by Vgs, is applied as an input to the fast slew circuit 610, the fast slew circuit 610 may operate without a dead zone for the input voltage VIN.

Meanwhile, when the magnitude of the input voltage VIN is less than the magnitude of the output voltage VOUT, the NMOS transistor MN8 included in the reference voltage compensation circuit 620 is turned off, and since no current flows through the NMOS transistor MN8, the first compensation current IC_PULL does not occur. In other words, the first compensation current IC_PULL is not supplied to the load stage 410.

After t1103, the input voltage VIN and output voltage VOUT may be maintained at a low level L.

As shown in FIG. 8, the fast slew circuit 610 may increase the slew rate by inputting a compensation voltage CVIN_F (i.e., the voltage at node N26) to the gate of the PMOS transistor MP12 of the compensation circuit 619, even when the difference between the input voltage VIN and the output voltage VOUT is small.

As shown in FIG. 10, when the input voltage VIN transitions from high level H to low level L, the transition period TP3(t1101 to t1103) of the output voltage VOUT when slew rate compensation is performed using a buffer circuit according to an embodiment is shorter than the transition period TP4(t1101 to t1105) of the output voltage VOUT when slew rate compensation is not performed.

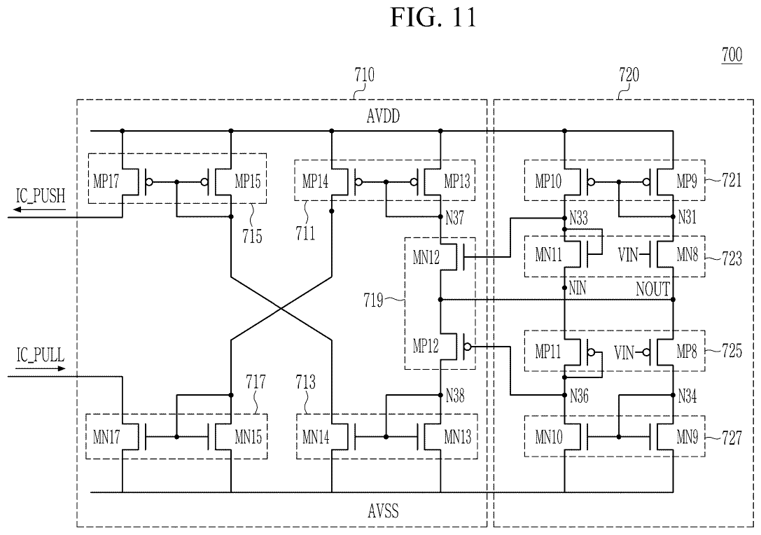

FIG. 11 is a circuit diagram of the slew rate compensating circuit of a buffer circuit according to one example embodiment. The slew rate compensating circuit 700 of FIG. 11 corresponds to the slew rate compensating circuit 220 of FIG. 2.

Referring to FIG. 11, the slew rate compensating circuit 700 may include a fast slew circuit 710 and a reference voltage compensation circuit 720. The slew rate compensating circuit 700 may generate a first compensation current IC_PULL or a second compensation current IC_PUSH based on the difference between the input voltage VIN and the output voltage VOUT.

The reference voltage compensation circuit 720 may include a node where the input voltage VIN is applied, an upper current mirror circuit 721, a first connection circuit 723, a lower current mirror circuit 727, and a second connection circuit 725.

The upper current mirror circuit 721 may include PMOS transistors MP9, MP10 connected in the form of a current mirror. The upper current mirror circuit 721 may be connected between the first node N31, the third node N33, and the supply power voltage AVDD. In one embodiment, the current ratio of the upper current mirror circuit 721 may be 1:1, but is not limited thereto.

The first connection circuit 723 may provide a bias voltage for the upper current mirror circuit 721 to perform a current mirroring operation. The first connection circuit 723 may include NMOS transistors MN8, MN11. The gate of NMOS transistor MN8 is connected to the input node VIN, the source is connected to the output node NOUT, and the drain may be connected to the first node N31. The gate and drain of NMOS transistor MN11 are connected to the third node N33, and the source may be connected to the input node VIN.

The lower current mirror circuit 727 may include NMOS transistors MN9, MN10 connected in the form of a current mirror. The lower current mirror circuit 727 may be connected between the fourth node N34, the sixth node N36, and the ground power voltage AVSS. In one embodiment, the current ratio of the lower current mirror circuit 727 may be 1:1, but is not limited thereto.

The second connection circuit 725 may provide a bias voltage for the lower current mirror circuit 727 to perform a current mirroring operation. The second connection circuit 725 may include PMOS transistors MP8, MP11. The gate of the PMOS transistor MP8 is connected to the input node VIN, the source is connected to the output node NOUT, and the drain may be connected to node N34. The gate and drain of the PMOS transistor MP11 are connected to node N36, and the source may be connected to the input node VIN.

The compensation voltage CVIN_R may be generated based on the voltage of the third node N33, which is the source of the PMOS transistor MP11. The compensation voltage CVIN_F may be generated based on the voltage of the sixth node N36, which is the source of the NMOS transistor MN11.

The fast slew circuit 710 may include a first upper current mirror circuit 711, a first lower current mirror circuit 713, a second upper current mirror circuit 715, a second lower current mirror circuit 717, and a compensation circuit 719.

The compensation circuit 719 may include an NMOS transistor MN12 and a PMOS transistor MP12 connected in series. The gate of the NMOS transistor MN12 is connected to the third node N33, the source is connected to the output node NOUT, and the drain may be connected to the seventh node N37. In other words, the NMOS transistor MN12 may receive the compensation voltage CVIN_R from the reference voltage compensation circuit 720 through the gate. The gate of the PMOS transistor MP12 is connected to the sixth node N36, the source is connected to the output node NOUT, and the drain may be connected to the eighth node N38. In other words, the PMOS transistor MP12 may receive the compensation voltage CVIN_F from the reference voltage compensation circuit 720 through the gate.

The first upper current mirror circuit 711 may include PMOS transistors MP13, MP14 connected in the form of a current mirror. The PMOS transistor MP13 may include a source connected to the supply power voltage AVDD, and a drain and gate connected to the seventh node N37. The PMOS transistor MP14 may include a source connected to the supply power voltage AVDD, a drain connected to the drain of the NMOS transistor MN15, and a gate connected to the seventh node N37.

The first lower current mirror circuit 713 may include NMOS transistors MN13, MN14 connected in the form of a current mirror. The NMOS transistor MN13 may include a source connected to the ground power voltage AVSS, and a drain and gate connected to the eighth node N38. The NMOS transistor MN14 may include a source connected to the ground power voltage AVSS, a drain connected to the drain of the PMOS transistor MP15, and a gate connected to the eighth node N38.

The second upper current mirror circuit 715 may include PMOS transistors MP15, MP16 connected in the form of a current mirror. The PMOS transistor MP15 may include a source connected to the supply power voltage AVDD, and a drain and gate connected to the drain of the NMOS transistor MN14. The PMOS transistor MP16 may include a source connected to the supply power voltage AVDD, a drain from which the second compensation current IC_PUSH is output, and a gate connected to the drain of the NMOS transistor MN14.

The second lower current mirror circuit 717 may include NMOS transistors MN15, MN16 connected in the form of a current mirror. The NMOS transistor MN15 may include a source connected to the ground power voltage AVSS, and a drain and gate connected to the drain of the PMOS transistor MP14. The NMOS transistor MN16 may include a source connected to the ground power voltage AVSS, a drain from which the first compensation current IC_PULL is output, and a gate connected to the drain of the PMOS transistor MP14.

Below, with reference to FIGS. 3 to 5 and 11, the operation of the buffer circuit according to one example embodiment will be described.

A buffer circuit may increase the slew rate of the output voltage VOUT of the buffer circuit by using the slew rate compensating circuits 500, 700 of FIGS. 5 and 11. Unless otherwise mentioned, the operation of the fast slew circuit 610 described with reference to FIGS. 6 to 8 may be equally applied to the operation of the fast slew circuit 710.

When the magnitude of the input voltage VIN becomes larger than the magnitude of the output voltage VOUT, the pulling load current ILD of the first input stage, composed of PMOS transistors MP1, MP2 included in the input stage 310, may decrease in magnitude, while the pulling load current ILDB may increase. Additionally, the pushing load current ILU of the second input stage, composed of NMOS transistors MN1, MN2 included in the input stage 310, may increase in magnitude, while the pushing load current ILUB may decrease. At this time, the voltage at the first output node NCU of the upper current mirror circuit 411 in the load stage 410 may decrease, and the voltage at the second output node NCSP may increase. Furthermore, the voltage at the first output node NCD of the lower current mirror circuit 416 in the load stage 410 may decrease, and the voltage at the second output node NCSN may increase. In other words, when the magnitude of the input voltage VIN is greater than the magnitude of the output voltage VOUT, the voltage at the first output node NCU of the upper current mirror circuit 411 in the load stage 410 and the voltage at the first output node NCD of the lower current mirror circuit 416 in the load stage 410 may decrease.

When the magnitude of the input voltage VIN is greater than the magnitude of the output voltage VOUT by a first voltage, and the first voltage is greater than or equal to the threshold voltage of the NMOS transistor MN8, the NMOS transistor MN8 of the reference voltage compensation circuit 720 in FIG. 11 may be turned on. Through the operation of the current mirror MP9, MP10 of the upper current mirror circuit (721), the NMOS transistor MN11 may be turned on. The gate and drain of the NMOS transistor MN11 are diode-connected, and since the input voltage VIN is applied to the source, the gate may have a voltage by adding the Vgs of the NMOS transistor MN11 to the input voltage VIN. In other words, the third node N33 may have a compensation voltage CVIN_R by adding the Vgs of the NMOS transistor MN11 to the input voltage VIN.

As a result, the sum of the input voltage VIN and Vgs may be applied to the gate of the NMOS transistor MN12. Subsequently, through the current mirror operation of the first upper current mirror circuit 711, current flows to the PMOS transistor MP14, and through the current mirror operation of the second lower current mirror circuit 717, the first compensation current IC_PULL may flow to the NMOS transistor MN16. The first compensation current IC_PULL may flow from the first output node NCD of the load stage 410 to the NMOS transistor MN16. In other words, the fast slew circuit 710 may pull the first compensation current IC_PULL.

At this time, the voltage of the first output node NCD of the load stage 410 may be further lowered by the first compensation current IC_PULL. The NMOS transistor MN7 of the output stage 420 is quickly turned off by the first compensation current IC_PULL, and the drop in the output voltage VOUT caused by the NMOS transistor MN7 is prevented, so the rising time of the output voltage VOUT may be shortened. Since the voltage of node N37, which is higher than the input voltage VIN by Vgs, is applied as an input to the fast slew circuit 710, the fast slew circuit 710 may operate without a dead zone for the input voltage VIN.

On the other hand, when the magnitude of the input voltage VIN is greater than the magnitude of the output voltage VOUT, the PMOS transistor MP8 included in the reference voltage compensation circuit 720 is turned off, and since no current flows through the PMOS transistor MP8, the second compensation current IC_PUSH does not occur. In other words, the second compensation current IC_PUSH is not supplied to the load stage 410.

When the magnitude of the input voltage VIN becomes smaller than the magnitude of the output voltage VOUT, the pulling load current ILD of the first input stage, which is composed of PMOS transistors MP1, MP2 included in the input stage 310, may increase, and the pulling load current ILDB may decrease. The pushing load current ILU of the second input stage, which is composed of NMOS transistors MN1, MN2 included in the input stage 310, may decrease, and the pushing load current ILUB may increase. At this time, the voltage at the first output node NCU of the upper current mirror circuit 411 of the load stage 410 may increase, and the voltage at the second output node NCSP may decrease. In addition, the voltage at the first output node NCD of the lower current mirror circuit 416 of the load stage 410 may increase, and the voltage at the second output node NCSN may decrease. For example, when the magnitude of the output voltage VOUT is greater than the magnitude of the input voltage VIN, the voltage at the first output node NCU of the upper current mirror circuit 411 of the load stage 410 and the voltage at the first output node NCD of the lower current mirror circuit 416 of the load stage 410 may increase.

When the magnitude of the input voltage VIN is smaller than the magnitude of the output voltage VOUT by a second voltage, and the second voltage is greater than or equal to the threshold voltage of the PMOS transistor MP8, the PMOS transistor MP8 in the reference voltage compensation circuit 720 of FIG. 11 may be turned on. Through the operation of the current mirror MN9, MN10 in the lower current mirror circuit 727, the PMOS transistor MP11 may be turned on. When the PMOS transistor MP11 is turned on, since the gate and drain of the PMOS transistor MP11 are diode-connected and the input voltage VIN is applied to the source, the gate may have a voltage obtained by subtracting the Vgs of the PMOS transistor MP11 from the input voltage VIN. In other words, the sixth node N36 may have a compensation voltage CVIN_F obtained by subtracting the Vgs value of the NMOS transistor MN11 from the input voltage VIN.

Accordingly, a value obtained by subtracting Vgs from the input voltage VIN may be applied to the gate of the PMOS transistor MP12. Subsequently, through the current mirror operation of the first lower current mirror circuit 713, current flows to the NMOS transistor MN14, and through the current mirror operation of the second upper current mirror circuit 715, a second compensation current IC_PUSH may flow to the PMOS transistor MP16. The second compensation current IC_PUSH may flow from the PMOS transistor MP16 to the first output node NCU of the load stage 410. In other words, the fast slew circuit 710 may push the second compensation current IC_PUSH.

At this time, the voltage of the first output node NCU of the load stage 410 may be further increased by the second compensation current IC_PUSH. Therefore, the PMOS transistor MP7 of the output stage 420 is quickly turned off by the second compensation current IC_PUSH, and the rise of the output voltage VOUT caused by the PMOS transistor MP7 is prevented, so the falling time of the output voltage VOUT can be shortened. Since the voltage of the eighth node N38, which is lower than the input voltage VIN by Vgs, is applied as an input to the fast slew circuit 710, the fast slew circuit 710 may operate without a dead zone for the input voltage VIN.

Meanwhile, when the magnitude of the input voltage VIN is smaller than the magnitude of the output voltage VOUT, the NMOS transistor MN8 included in the reference voltage compensation circuit 720 is turned off, and no current flows through the NMOS transistor MN8, so the first compensation current IC_PULL does not occur. In other words, the first compensation current IC_PULL is not supplied to the load stage 410.

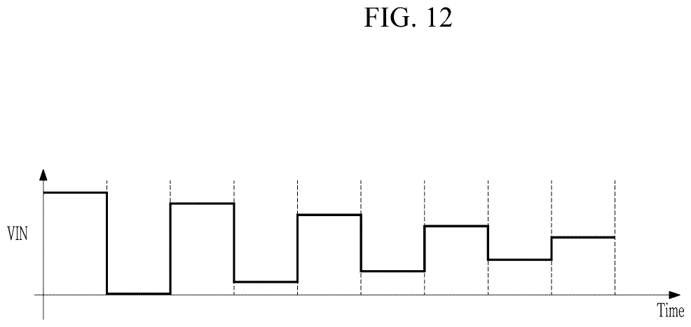

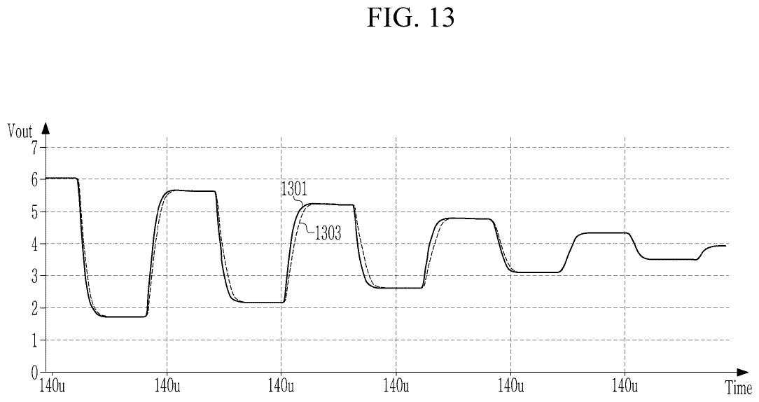

FIG. 12 is a timing diagram illustrating the input voltage of the buffer circuit according to an example embodiment. FIG. 13 is a timing diagram illustrating the output voltage when the input voltage according to FIG. 12 is applied to the buffer circuit according to an example embodiment.

As shown in FIG. 12, an input voltage VIN with a rapidly changing magnitude may be applied to the buffer circuit 100.

In FIG. 13, the first graph 1301 shows the output voltage VOUT when slew rate compensation is performed using the buffer circuit 100 according to one embodiment. Specifically, the first graph 1301 illustrates the output voltage VOUT when an input voltage VIN is applied to the buffer circuit 100 that includes a reference voltage compensation circuit 520 and a fast slew circuit 510. In other words, the first graph 1301 is a graph showing the output voltage VOUT when slew rate compensation is performed while performing reference voltage compensation. The second graph 1303 shows the output voltage VOUT when slew rate compensation is performed without performing reference voltage compensation.

As shown in FIG. 13, the transition period of the first graph 1301 may be shorter than the transition period of the second graph 1303.

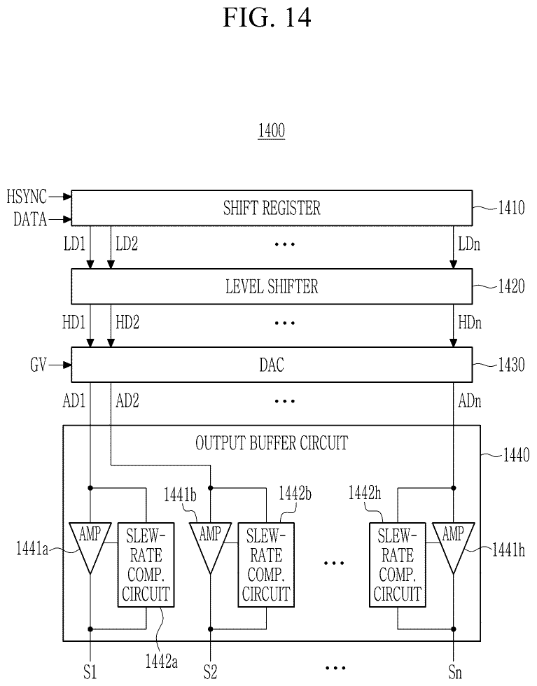

FIG. 14 is a block diagram illustrating a source driver including a buffer circuit according to an example embodiment.

Referring to FIG. 14, a source driver 1400 may include a shift register 1410, a level shifter 1420, a digital-analog converter (DAC) 1430, and an output buffer circuit 1440.

The shift register 1410 samples data DATA in response to a horizontal synchronizing signal HSYNC and provide sampled image data LD1, . . . , LDk to the level shifter 1420. The data DATA may include a plurality of source data corresponding to a plurality of source lines and each of the plurality of source data may include a plurality of bits. The shift register 1410 may sample each of the plurality of bits of the data DATA and may generate image data LD1, . . . , LDk having the plurality of bits. The horizontal synchronizing signal HSYNC may be a signal having a predetermined period, and may be a signal which determines a scan period of pixels connected to each of the gate lines.

The level shifter 1420 may level shift an image data LD1, LD2, . . . , LDn. The level shifter 1420 may receive image data LD1, LD2, . . . , LDn of a low voltage level to output decoded image data HD1, HD2, . . . , HDn of a high voltage level to the DAC 1430. In some embodiment, the image data LD1 may include a plurality of bits and the level shifter 1420 shifts levels of the plurality of bits of the image data LD1, LD2, . . . , LDn to generate decoded image data HD1, HD2, . . . , HDn having a plurality of bits. The level shifter 1420 may receive the digital signals LD1, LD2, . . . , LDn to provide decoded image data HD1, HD2, . . . , HDn whose level transitions to swing between target voltage levels to the DAC 1430.

The DAC 1430 may output analog signals AD1, AD2, . . . , ADn corresponding to the decoded image data HD1, HD2, . . . , HDn. The DAC 1430 may receive a plurality of gamma voltages GV together with the decoded image data HD1, HD2, . . . , HDn. The DAC 1430 may select at least some of the plurality of gamma voltages GV based on the decoded image data HD1, HD2, . . . , HDn to transmit the selected gamma voltages to the output buffer circuit 1440 through an output port as an input voltage.

The output buffer circuit 1440 may buffer the analog signals AD1, AD2, . . . , ADn which are transmitted from the DAC 1430 to output the buffered analog signals to pixels connected to the source lines as data signals S1, S2, . . . , Sn. The output buffer circuit 1440 may include a plurality of operational amplifiers 1441a, 1441b, . . . , 1441h connected to the plurality of source lines and a plurality of slew rate compensating circuits 1442a, 1442b, . . . , 1442h corresponding to the plurality of operational amplifiers 1441a, 1441b, . . . , 1441h. The output buffer circuit 1440 of the source driver 1400 of FIG. 14 has a configuration of a buffer circuit according to the embodiments. The plurality of operational amplifiers 1441a, 1441b, . . . , 1441h may amplify the analog signals AD1, AD2, . . . , ADn from the DAC 1430 to generate data signals S1, S2, . . . , Sn. The plurality of slew rate compensating circuits 1442a, 1442b, . . . , 1442h may generate a compensation voltage based on analog signals AD1, AD2, . . . , ADn. The plurality of slew rate compensating circuits 1442a, 1442b, . . . , 1442h may generate a compensation current based on a voltage difference of the compensation voltage and the data signals S1, S2, . . . , Sn and may supply the compensation current to each of the plurality of operational amplifiers 1441a, 1441b, . . . , 1441h. The compensation current may be proportional to the voltage difference of the analog signals AD1, AD2, . . . , ADn and the data signals S1, S2, . . . , Sn. Specifically, when the voltage difference of the analog signals AD1, AD2, . . . , ADn and the data signals S1, S2, . . . , Sn is generated, the plurality of slew rate compensating circuits 1442a, 1442b, . . . , 1442h may generate a compensation current. The transition time of the output voltage may be reduced so that the source driver 1400 which includes the output buffer circuit 1440 may be driven at a low power and may be also driven at a high display frame rate.

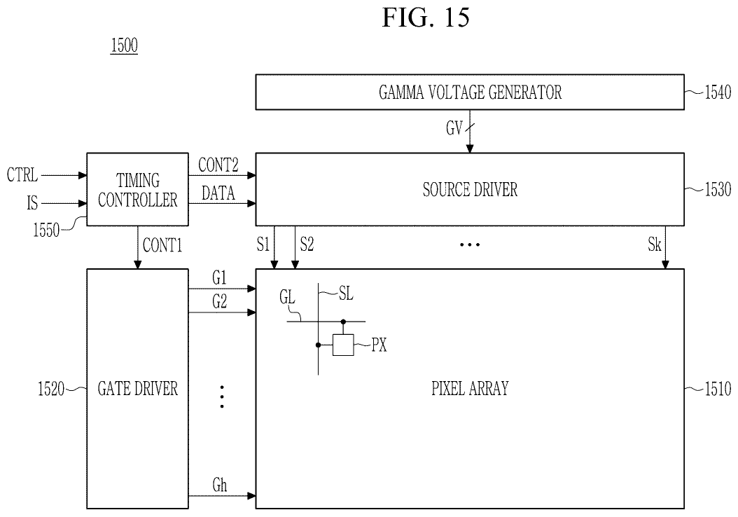

FIG. 15 is a block diagram illustrating a display device including a source driver according to an example embodiment.

Referring to FIG. 15, a display device 1500 according to an embodiment may include a pixel array 1510, a gate driver 1520, a source driver 1530, a gamma voltage generator 1540, and a timing controller 1550.

A plurality of pixels PX for displaying images may be located in the pixel array 1510. The pixel PX may be connected to a corresponding source line SL among a plurality of source lines and a corresponding gate line GL among a plurality of gate lines. The pixel PX may receive a data signal from the source line SL when the gate signal is supplied to the gate line GL. The pixel PX expresses light with a predetermined luminance corresponding to the input data signal. The plurality of pixel PX displays an image in one frame unit.

When the display device 1500 is an organic light emitting display device, each pixel PX may include a plurality of transistors including a driving transistor and an organic light-emitting diode. The driving transistor included in the pixel PX may supply a current corresponding to the data signal to the organic light-emitting diode and the organic light-emitting diode correspondingly emits light with a predetermined luminance. When the display device 1500 is a liquid crystal display device, each pixel PX may include a switching transistor and a liquid crystal capacitor. The pixel PX controls a transmittance of the liquid crystal in response to the data signal to supply the light with a predetermined luminance to the outside.

Even though in FIG. 15, it is illustrated that the pixel PX may be connected to one source line SL and one gate line GL, a connection structure of the signal line of the pixel PX of the display device according to the embodiment is not limited thereto. For example, various signal lines may be further connected in response to the circuit structure of the pixel PX. In the embodiment, the pixel PX may be implemented in various currently known forms.

The gate driver 1520 may supply a plurality of gate signals G1, G2, . . . , Gh. The plurality of gate signals G1, G2, . . . , Gh may be pulse signals having an enable level and a disable level. The plurality of gate signals G1, G2, . . . , Gh may be applied to the plurality of gate lines GL. When a gate signal of the enable level is applied to the gate line GL connected to the pixel PX, a data signal applied to the source line SL connected to the pixel PX may be transmitted to the pixel PX. The gate driver 1520 may supply the plurality of gate signal G1, G2, . . . , Gh during a plurality of horizontal periods. One frame may include a plurality of horizontal periods.

The source driver 1530 may receive a digital signal type of data DATA from the timing controller 1550 and converts the data DATA into an analog signal type of data signals S1, S2, . . . , Sk. Here, the data DATA may include gray information corresponding to each pixel PX to display the image signal may be on the pixel array 1510. The source driver 1530 transmits the plurality of data signals S1, S2, . . . , Sk to the pixel array 1510 according to the source driver control signal CONT3 supplied from the timing controller 1550. The source driver 1530 may be referred to as a data driver. In some embodiment, the source driver control signal CONT3 may include at least one of enable signals EN1, EN2, and EN and switching control signals SCS, SCS1, and SCS2 which have been described above.

The source driver 1530 may be electrically connected to the plurality of source lines SL. The source driver 1530 transmits the plurality of data signals S1, S2, . . . , Sk to the plurality of electrically connected source lines SL. The source driver 1530 may have the same configuration as the source driver 1400 of FIG. 14. Accordingly, the display device 1500 may include an output buffer circuit of the embodiment. The source driver 1530 may include a plurality of operational amplifiers which amplifies the input voltage and outputs the output voltage and a plurality of slew rate compensating circuits. Each of the plurality of slew rate compensating circuits may generate a compensation voltage based on the input voltage and generate a compensation current based on the difference between the compensation voltage and the output voltage. The transition time of the output voltage may be reduced so that the display device 1500 including the source driver 1530 may be driven at a low power and also may be driven at a high display frame rate.

The gamma voltage generator 1540 determines a magnitude of each of a plurality of gamma voltages GV based on an operating condition or gamma voltage register setting of the display device 1500. In the embodiment, the number of plurality of gamma voltages GV may be determined according to a number of bits of the image data. When the image data has n bits, the plurality of gamma voltages GV may have 2n different magnitudes. The gamma voltage generator 1540 selects at least some of the plurality of reference voltages to determine a magnitude of each of the plurality of gamma voltages GV.

The timing controller 1550 may receive an image signal IS and a driving control signal CTRL from the host device and control the gate driver 1520 and the source driver 1530. Here, the host device may be a computing device or system which controls the display device 1500 to display an image desired by a user on the pixel array 1510 from the outside. The driving control signal CTRL provided from the host device may include a control instruction and predetermined data to control the gate driver 1520 and the source driver 1530. The timing controller 1550 controls the gate driver 1520 and the source driver 1530 based on the driving control signal CTRL. For example, the driving control signal CTRL may include a horizontal synchronizing signal HSYNC, a vertical synchronization signal VSYNC, a main clock signal MCLK, and a data enable signal DE. The timing controller 1550 divides the image signal IS in one frame unit based on the vertical synchronization signal VSYNC and divides the image signal IS in a gate line GL unit based on the horizontal synchronizing signal HSYNC to generate data DATA. The timing controller 1550 may transmit the gate driver control signal CONT1 and the source driver control signal CONT2 to the gate driver 1520 and the source driver 1530, respectively, to control the synchronization of the operations of the source driver 1530 and the gate driver 1520, for example.

The pixel array 1510 and the gate driver 1520 may be implemented on the same substrate and the source driver 1530 and the timing controller 1550 are configured in one chip. In some embodiment, the pixel array 1510, the gate driver 1520, the source driver 1530, and the timing controller 1550 may be implemented on the same substrate. In some embodiment, the gate driver 1520, the source driver 1530, and the timing controller 1550 may be configured as one chip. The gate driver 1520 may be implemented as a separate semiconductor die, chip, or module to be connected to the pixel array 1510. Further, a part of the gate driver 1520 may be located on the substrate on which the pixel array 1510 may be located and the other part may be included in a separate chip.

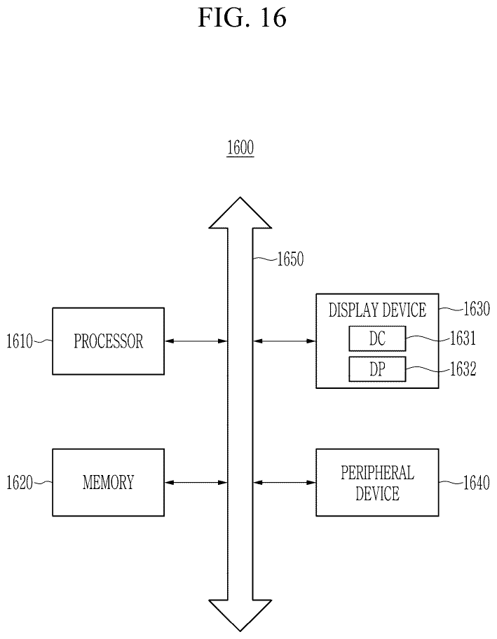

FIG. 16 is a diagram for explaining a display system according to an example embodiment.

Referring to FIG. 16, a display system 1600 according to an embodiment may include a processor 1610, a memory 1620, a display device 1630, and a peripheral device 1640 which are electrically connected to a system bus 1650.

The processor 1610 controls the data input/output of the memory 1620, the display device 1630, and the peripheral device 1640 and may perform the image processing of the image data which are transmitted between the corresponding devices. The processor 1610 may be a computer (or several interconnected computers) and can include, for example, one or more processors configured by software, such as a CPU (Central Processing Unit), GPU (graphics processor), controller, etc.

The memory 1620 may include a volatile memory such as a dynamic random access memory (DRAM) and/or a non-volatile memory such as a flash memory. The memory 1620 may be configured by a DRAM, a phase-change random access memory (PRAM), a magnetic random access memory (MRAM), a resistive random access memory (ReRAM), a ferroelectric random access memory (FRAM), a NOR flash memory, a NAND flash memory, and a fusion flash memory (for example, a memory in which a static random access memory (SRAM) buffer and a NAND flash memory and a NOR interface logic are coupled). The memory 1620 may store image data acquired from the peripheral device 1640 or stores image signal processed in the processor 1610.

The display device 1630 may include a driving circuit 1631 and a display panel 1632 and the driving circuit 1631 displays image data applied through the system bus 1650 on the display panel 1632. The driving circuit 1631 may include a source driver 1400 of FIG. 14. Specifically, the driving circuit 1631 may include a plurality of operational amplifiers which amplifies an input voltage and outputs an output voltage and a plurality of slew rate compensating circuits which generates a compensation current based on a difference of the input voltage and the output voltage. The transition time of the output voltage may be reduced so that the display device 1630 including the driving circuit 1631 may be driven at a low power and may be also driven at a high display frame rate.

The peripheral device 1640 may be a device which converts a moving image or a still image into an electric signal, such as a camera, a scanner, or a web cam. The image data acquired through the peripheral device 1640 may be stored in the memory 1620 and may be displayed on the display panel 1632 in real time.

The display system 1600 may be equipped in a mobile electronic product, such as a smart phone, but may be not limited thereto and may be equipped in various types of electronic products which display images.

In some embodiments, each component or a combination of two or more components described with reference to FIGS. 1 to 16 may be implemented as a digital circuit, programmable or non-programmable logic device or array, application-specific integrated circuit (ASIC), and the like.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A buffer circuit comprising:
an operational amplifier configured to output an output voltage based on a voltage of a first output node and a second output node which vary in response to an input voltage of the operational amplifier; and
a slew rate compensating circuit configured to receive the input voltage and the output voltage, generate a compensation voltage based on the input voltage, generate a compensation current based on the compensation voltage, and supply the compensation current to the first output node or the second output node.

2. The buffer circuit of claim 1, wherein the slew rate compensation circuit comprises:
a reference voltage compensation circuit configured to generate the compensation voltage based on the input voltage; and
a fast slew circuit comprising a compensation circuit configured to receive the compensation voltage, perform a current mirror operation for a current flowing in the compensation circuit, and generate the compensation current.

3. The buffer circuit of claim 2,
wherein the compensation circuit comprises a first transistor and a second transistor connected in series,
wherein when the input voltage is greater than the output voltage, a first compensation voltage obtained by adding a first reference voltage to the input voltage is applied to the first transistor, and
wherein when the input voltage is less than the output voltage, a second compensation voltage obtained by subtracting a second reference voltage from the input voltage is applied to the second transistor.

4. The buffer circuit of claim 3,
wherein the reference voltage compensation circuit comprises a third transistor including a gate receiving the input voltage, a source receiving the output voltage, and a drain connected to the gate of the first transistor, and
wherein the first reference voltage is a gate-to-source voltage of the third transistor.

5. The buffer circuit of claim 4,
wherein the reference voltage compensation circuit comprises a fourth transistor including a gate receiving the input voltage, a source receiving the output voltage, and a drain connected to the gate of the second transistor, and
wherein the second reference voltage is a gate-to-source voltage of the fourth transistor.

6. The buffer circuit of claim 3,
wherein the reference voltage compensation circuit comprises a first connection circuit and a first current mirror circuit connected to the first connection circuit,
wherein the first connection circuit comprises:
a third transistor including a gate receiving the input voltage, a source receiving the output voltage, and a drain connected to the gate of the first transistor; and
a seventh transistor including a gate receiving the input voltage, a source receiving the output voltage, and a drain connected to the first current mirror circuit, and
wherein the first current mirror circuit is configured to perform a mirror operation for a current flowing through the seventh transistor.

7. The buffer circuit of claim 6,
wherein the reference voltage compensation circuit comprises a second connection circuit and a second current mirror circuit connected to the second connection circuit,
wherein the second connection circuit comprises:
a fourth transistor including a gate receiving the input voltage, a source receiving the output voltage, and a drain connected to the gate of the second transistor; and
an eighth transistor including a gate receiving the input voltage, a source receiving the output voltage, and a drain connected to the second current mirror circuit, and
wherein the second current mirror circuit performs a mirror operation for a current flowing through the eighth transistor.

8. The buffer circuit of claim 3,
wherein the reference voltage compensation circuit comprises a fifth transistor including a gate and a drain connected to the gate of the first transistor, and a source receiving the input voltage, and
wherein the first reference voltage is a gate-to-source voltage of the fifth transistor.

9. The buffer circuit of claim 8,
wherein the reference voltage compensation circuit comprises a sixth transistor including a gate and a drain connected to the gate of the second transistor, and a source receiving the input voltage, and
wherein the second reference voltage is a gate-to-source voltage of the sixth transistor.

10. The buffer circuit of claim 3,
wherein the operational amplifier is configured to decrease the output voltage based on the voltage of the first output node, and increase the output voltage based on the voltage of the second output node, and
wherein the fast slew circuit configured to provide the compensation current to the first output node to prevent the output voltage from decreasing when the input voltage is greater than the output voltage, and provide the compensation current to the second output node to prevent the output voltage from increasing when the input voltage is less than the output voltage.

11. The buffer circuit of claim 10,
wherein the compensation current provided to the first output node includes a first compensation current that sinks current from the first output node, and
wherein the compensation current provided to the second output node includes a second compensation current that supplies current to the second output node.

12. The buffer circuit of claim 1, wherein the operational amplifier comprises:
an input stage configured to receive the input voltage and the output voltage and determine a difference in magnitude between the input voltage and the output voltage;
a load stage configured to generate load currents corresponding to the difference in magnitude between the input voltage and the output voltage, and provide the load currents from the first and second output nodes to the input stage; and
an output stage configured to generate the output voltage based on the voltages of the first and second output nodes.

13. The buffer circuit of claim 12, wherein the input stage comprises:
a first input stage including PMOS transistors and configured to receive a pulling load current from the load stage; and
a second input stage including NMOS transistors and configured to receive a pushing load current from the load stage.

14. The buffer circuit of claim 13, wherein the load stage comprises:
an upper current mirror circuit electrically connected to the second input stage and configured to supply current to the load stage;
a lower current mirror circuit electrically connected to the first input stage and configured to supply current to the load stage;
a first connection circuit electrically connecting a first output node of the upper current mirror circuit to a first output node of the lower current mirror circuit;
a second connection circuit electrically connecting a second output node of the upper current mirror circuit to a second output node of the lower current mirror circuit;
a first capacitor connected between the first output node of the upper current mirror circuit and an output node of the output stage; and
a second capacitor connected between the first output node of the lower current mirror circuit and the output node of the output stage.

15. A source driver comprising:
a shift register configured to sample data in response to a horizontal synchronization signal and output sampled image data;
a level shifter configured to shift a voltage level of the image data;
a digital-analog converter (DAC) configured to generate an analog signal corresponding to the image data having the shifted voltage level; and
an output buffer circuit configured to buffer the analog signal and output the buffered analog signal as a data signal to source lines, generate a compensation voltage based on the buffered analog signal, and generate a compensation current based on the compensation voltage to cause the data signal to rise or fall.

16. The source driver of claim 15, wherein the output buffer circuit comprises:
a plurality of operational amplifiers configured to amplify the analog signal to generate the data signal; and
a plurality of slew rate compensation circuits configured to provide the compensation current to respective ones of the plurality of operational amplifiers when a voltage difference occurs between the analog signal and the data signal.

17. The source driver of claim 16, wherein each of the slew rate compensation circuits comprises:
a reference voltage compensation circuit configured to generate the compensation voltage based on the analog signal; and
a fast slew circuit comprising a compensation circuit configured to receive the compensation voltage, perform a current mirror operation for a current flowing in the compensation circuit, and generate the compensation current.

18. The source driver of claim 17,
wherein the compensation circuit comprises a first transistor and a second transistor connected in series,
wherein, when the analog signal is greater than the data signal, a first compensation voltage obtained by adding a first reference voltage to the analog signal is applied to the first transistor, and
wherein, when the analog signal is less than the data signal, a second compensation voltage obtained by subtracting a second reference voltage from the analog signal is applied to the second transistor.

19. A display device comprising:
a pixel array comprising a plurality of pixels;
a timing controller configured to receive an image signal from an outside and generate image data by separating the image signal; and
a source driver configured to convert the image data into a data signal, generate a compensation voltage based on an analog signal corresponding to the image data, and generate a compensation current based on the compensation voltage to cause the data signal to rise or fall.

20. The display device of claim 19,
wherein the source driver comprises:
a plurality of operational amplifiers configured to amplify the analog signal to generate the data signal; and
a plurality of slew rate compensation circuits configured to provide the compensation current to respective ones of the plurality of operational amplifiers when a voltage difference occurs between the analog signal and the data signal,
wherein each of the plurality of slew rate compensation circuits comprises:
a reference voltage compensation circuit configured to generate the compensation voltage based on the analog signal; and
a high-speed slew circuit comprising a compensation circuit, the high-speed slew circuit configured to generate the compensation current, wherein the compensation circuit is configured to receive the compensation voltage and perform a current mirror operation for a current flowing in the compensation circuit,
wherein the compensation circuit comprises a first transistor and a second transistor connected in series,
wherein, when the analog signal is greater than the data signal, a first compensation voltage obtained by adding a first reference voltage to the analog signal is applied to the first transistor, and
wherein, when the analog signal is smaller than the data signal, a second compensation voltage obtained by subtracting a second reference voltage from the analog signal is applied to the second transistor.
